(19) United States
(12) Patent Application Publication
(10) Pub. No.: US 2024/0326601 A1
(43) Pub. Date: Oct. 3, 2024

(54) Power Supply Device for a Vehicle, Vehicle, and Vehicle Infrastructure

(71) Applicant: Siemens Mobility Austria GmbH, Wien (AT)

(72) Inventors: Christopher FLOIS, Tulln an der Donau (AT); Georg HAVLICEK, Wien (AT); Christian SALIGER, Wien, Wien (AT)

(21) Appl. No.: 18/580,043

(22) PCT Filed: Jul. 14, 2022
(86) PCT No.: PCT/EP2022/069782

§ 371 Date: Jan. 17, 2024

(30) Foreign Application Priority Data
Jul. 19, 2021 (AT) A50597/2021

(51) Int. Cl. B60L 5/36; B60L 53/16; B60L 53/35

(52) U.S. Cl. CPC B60L 5/36; B60L 53/16; B60L 53/35; B60L 2200/18; B60L 2200/36

(57) ABSTRACT

A power supply device for a vehicle, in particular for a utility vehicle such as an electric bus or an electric heavy goods vehicle, wherein the power supply device includes at least one contact head that can be brought in contact with a docking station to establish an electrical connection, and includes at least a first pivot arm that is connected to the at least one contact head, where the at least first pivot arm is connectable to a vehicle so as to be rotatable about a first axis and a second axis that extend at an angle from one another, where the first axis extends parallel to a transverse vehicle axis, and the second axis extends parallel to a longitudinal vehicle axis so as to allow for more flexible movability of the contact head.

### CROSS-REFERENCE TO RELATED APPLICATIONS

This is a U.S. national stage of application No. PCT/EP2022/069782 filed 14 Jul. 2022. Priority is claimed on Austrian Application No. A50597/2021 filed 19 Jul. 2021, the content of which is incorporated herein by reference in its entirety.

### BACKGROUND OF THE INVENTION

### 1. Field of the Invention

The invention relates to a power supply device for a vehicle, particularly for a utility vehicle such as an electric bus or an electric truck, which includes at least one contact head that can be brought into contact with a docking station to establish an electrical connection, and which includes at least one first pivot arm that is connected to the at least one contact head.

### 2. Description of the Related Art

Power supply devices with contact heads can be brought into contact with docking stations (for example, contact hoods of charging columns of a vehicle infrastructure). Electrical connections between the contact heads and the docking stations result in the contact heads being supplied with electricity. The contact heads are frequently connected to roofs of vehicles (for example, electric buses or trucks) via rod systems or pivot arms, as a result of which current can be drawn via the docking stations and can be supplied to the vehicles via the rod systems. As a result, batteries or accumulators of the vehicles can, for example, be charged (for example, in a bus or truck depot and/or at a bus stop).

To safeguard connection procedures between the contact heads and the docking stations, even in the event of translatory misalignments between the contact heads and the docking stations (which can occur, for example, if the vehicles are not positioned precisely in respect of the docking stations), the contact heads are frequently connected to the rod systems via guide rails, which enable translatory movements between the contact heads and the rod systems.

DE 10 2012 202 955 A1, for example, shows a charge current collector, via which an energy store of an electric vehicle can be charged up by current transmitted from a stationary charging station. A platform with electric contacts is coupled to a current collector rod system. The current collector rod system is connected to the vehicle.

However, DE 10 2012 202 955 A1 does not make clear the extent to which the current collector rod system and the platform can offset any misalignment between the vehicle and the charging station.

### SUMMARY OF THE INVENTION

It is an object of the invention to provide a power supply device which is developed further in comparison with the prior art and which enables particularly precise contacting procedures between a contact head and a docking station, together with a robust connection between the contact head and one or more pivot arms.

This and other objects and advantages are achieved in accordance with the invention by a power supply device in which the at least first pivot arm can be connected to a vehicle so as to be rotatable about a first axis and a second axis, which are arranged at an angle to one another, where the first axis extends parallel to a transverse vehicle axis and the second axis extends parallel to a longitudinal vehicle axis. As a result, the contact head can be brought into contact with the docking station of a power transmission device via pivot arm movements. The first pivot arm is mounted (for example, on a vehicle or at a charging station) such that it can execute first rotary movements extending parallel to a transverse vehicle axis and second rotary movements extending parallel to a longitudinal vehicle axis. With such a mounting, the contact head can be raised due to the first rotary movements and delivered to the docking station, and due to the second rotary movement can be oriented transversely to the vehicle, until a position with respect to the docking station that is suitable for current transmission is reached and electric first contacts of the contact head can be brought into contact with electric second contacts of the docking station.

Due to the second rotary movement, the contact head can execute a translatory movement, without a translatory relative movement between the contact head and the first pivot arm being necessary for this movement. It is possible to dispense with structure, such as guide rails and sliding bearings, between the contact head and the first pivot arm.

A precise orientation of the contact head in or on the docking station as well as secure electric contacting of the docking station by the contact head are achieved.

The first rotary movements of the first pivot arm can, for example, be performed via an electric first rotary drive, whose first rotary axis extends in the first axis that can be connected to the vehicle and that is coupled to the first pivot arm. The second rotary movements of the first pivot arm can, for example, be performed via an electric second rotary drive, whose second rotary axis extends in the second axis that can be connected to the vehicle and that is coupled to the first pivot arm.

A stabilizing effect on the contact head is achieved if, in order to safeguard the at least one contact head against distortions relative to the at least first pivot arm, a guide device is connected to the at least one contact head and can be connected to the vehicle.

In order, in the case of a power supply device in accordance with the invention, to enable the contact head to retain its orientation even in the event of pivoting movements, it is helpful if a spherical joint is arranged between the at least first pivot arm and the at least one contact head.

A mechanically particularly stable support for the contact head is achieved if a second pivot arm is connected to the at least one contact head, where the second pivot arm that can be rotated parallel to the first axis and parallel to the second axis can be connected to the vehicle, where the second pivot arm is guided in parallel to the first pivot arm such that in the event of pivoting movements of the first pivot arm and of the second pivot arm the at least one contact head performs a translatory movement. By this measure, guidance of the contact head comparable to parallelogram guidance is enabled.

A mechanically robust and industrially easily implemented embodiment with respect to the guide device is achieved if the guide device, formed in the shape of a rod, is articulated to the at least one contact head and can be articulated to the vehicle.

However, as an alternative to a rod-shaped guide device, it may also be advantageous (for example, if flexibly adjustable forces exerted by the guide device on the contact head, are necessary or desired) if the guide device is formed as a cable-pull arrangement that is connected to the at least one contact head and can be connected to the vehicle, where the cable-pull arrangement is configured such that the at least one contact head can be balanced by adjusting cable forces on at least the first pivot arm.

To protect the guide device against environmental influences, it may be advantageous if at least one first cable of the cable-pull arrangement is sheathed by a protective tube.

To guide the first pivot arm or a plurality of pivot arms in an unstressed state back into a neutral position or to avoid the first pivot arm or the plurality of pivot arms being deflected immediately prior to a contact of the contact head with the docking station (for example, due to wind load), it may be helpful if a spring device is connected to at least the first pivot arm and can be connected to the vehicle, where the spring device is adjusted such that if the pivot arm is deflected out of a neutral position a spring return force is formed on at least the first pivot arm.

To enable rotations of the first pivot arm or of the plurality of pivot arms about two axes that are oriented at right angles to one another, it is advantageous if the first axis and the second axis are formed as axes of a Cartesian coordinate system.

A transmission of current into the vehicle (for example, from a charging station or from an overhead line or a conductor rail, etc.) is, for example, enabled if at least the first pivot arm is connected to the at least one contact head to form a current collector.

It is advantageous if the docking station is arranged so as to be stationary.

The docking station can, for example, be part of a charging station or can be connected to a charging column. By this measure, it is, for example, possible to equip a stopping point or a vehicle depot with the docking station.

The objects and advantages in accordance with invention are additionally achieved by a vehicle with a power supply device in accordance with the invention.

The objects and advantages in accordance with invention are further achieved by a vehicle infrastructure (for example, a charging station) with a power supply device in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below using exemplary embodiments, in which:

FIG. 1 shows a schematic front view illustration of an exemplary first embodiment of a power supply device in accordance with the invention arranged on a vehicle roof, with a first pivot arm and a first guide rod system and a second guide rod system that are connected to a contact head;

FIG. 2 shows a schematic side view illustration of the exemplary first embodiment f a power supply device in accordance with the invention;

FIG. 3 shows a schematic front view illustration of an exemplary second embodiment of a power supply device in accordance with the invention arranged on a vehicle roof, with a first pivot arm and a guide device embodied as a cable-pull arrangement that are connected to a contact head; and

FIG. 4 shows a schematic front view illustration of an exemplary third embodiment of a power supply device in accordance with the invention arranged on a vehicle roof, with a first pivot arm and a second pivot arm as well as a first guide rod system that are connected to a contact head.

### DETAILED DESCRIPTION OF THE EXEMPLARY EMBODIMENTS

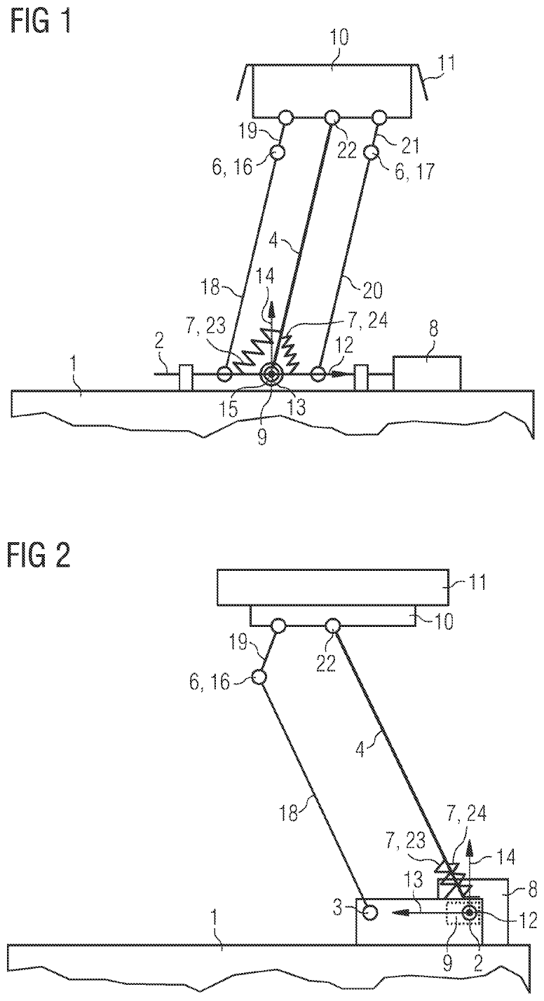

A schematic front view illustrated in FIG. 1 shows an exemplary first embodiment of a power supply device in accordance with the invention formed as a charge current collector of an electric vehicle 1, which is configured as a bus, i.e., as a utility vehicle. In accordance with the invention, it is also conceivable for the charge current collector to be provided for an electric truck, etc.

The charge current collector is arranged on a roof of the vehicle 1 and comprises a first base rod 2, a second base rod 3 (visible in FIG. 2), a first pivot arm 4, a guide device 6, a spring device 7, a first rotary drive 8, a second rotary drive 9 and a contact head 10, which is brought mechanically and electrically into contact with a stationary docking station 11, formed as a contact hood, of a charging station, i.e., of a vehicle infrastructure. As a result, electric current is transmitted from the charging station via the docking station 11, the contact head 10 and current-conducting parts (for example, via the first pivot arm 4) of the charge current collector into an energy store, formed as an accumulator, of the vehicle 1.

Via the first base rod 2 and the second base rod 3, the first pivot arm 4 and the guide device 6 are mounted in an articulated manner on the roof of the vehicle 1.

The first base rod 2 is mounted on the vehicle 1 so as to be rotatable about a first axis 12 of a Cartesian coordinate system.

The first pivot arm 4 is coupled to the first base rod 2 via a pivot joint 15 so as to be rotatable about a second axis 13 appearing projected in FIG. 1, and visible in FIG. 2. The first base rod 2 is coupled to the electric first rotary drive 8, and by means thereof first rotary movements of the first pivot arm 4 about the first axis 12 can be initiated and guided. In FIG. 1, the first pivot arm 4 is in a state deflected with respect to the first axis 12, this being visible in FIG. 2.

The electrical second rotary drive 9 is coupled to the pivot joint 15, and by means thereof second rotary movements of the first pivot arm 4 about the second axis 13 can be initiated and guided.

The first rotary drive 8 and the second rotary drive 9 are supplied with current from the accumulator of the vehicle 1 via supply lines (not shown in FIG. 1).

The first pivot arm 4 is thus connected to the vehicle 1 so as to be rotatable about the first axis 12 and the second axis 13, which are arranged at an angle of 90° to one another.

The first axis 12 is oriented in parallel to a transverse vehicle axis of the vehicle 1 (not shown in FIG. 1), the second axis 13 in parallel to a longitudinal vehicle axis of the vehicle 1, likewise not illustrated in FIG. 1.

The first rotary movements and the second rotary movements can be performed simultaneously or sequentially, or staggered or alternately. With the first rotary movements the contact head 10 is raised (i.e., moved in a mathematically positive direction of a third axis 14) and lowered (i.e., moved in a mathematically negative direction of the third axis 14), and via the second rotary movements is positioned in parallel to the transverse vehicle axis of the vehicle 1 or in parallel to the first axis 12 in a translatory manner in relation to the docking station 11.

The guide device 6 is rod-shaped and comprises a first guide rod system 16 with a first guide rod 18 and a second guide rod 19, which are articulated to one another and a second guide rod system 17 with a third guide rod 20 and a fourth guide rod 21, which are likewise articulated to one another.

The first guide rod 18 and the third guide rod 20 are articulated to the second base rod 3. The second base rod 3 is arranged in parallel to the first base rod 2 and is mounted on the vehicle 1 so as to be rotatable in parallel to the first axis 12.

The first pivot arm 4, the first guide rod system 16 and the second guide rod system 17 are articulated to the contact head 10. A spherical joint 22 is arranged between the first pivot arm 4 and the contact head 10.

Ends of the first pivot arm 4, of the first guide rod system 16 and of the second guide rod system 17 form a three-point support or a three-point mounting for the contact head 10. The first pivot arm 4, the first guide rod system 16 and the second guide rod system 17 are connected to one another via the contact head 10. If the first pivot arm 4 is deflected about the first axis 12 and/or the second axis 13, then the first guide rod system 16 and the second guide rod system 17 move along with the first pivot arm 4. The contact head 10 is balanced on the first pivot arm 4 via the first guide rod system 16 and the second guide rod system 17. Undesired tilting movements (for example, in parallel to the first axis 12) are avoided. The contact head 10 is safeguarded against distortions relative to the first pivot arm 4.

The spring device 7 is connected to the first pivot arm 4 and the first base rod 2. This comprises a first spring 23 and a second spring 24. Viewed from the first pivot arm 4 and in the view in FIG. 1, the first spring 23 points down to the left, the second spring 24 down to the right. If the first pivot arm 4, for example, deflects to the right with respect to the view in FIG. 1 and as illustrated in FIG. 1, then the first spring 23 is stretched and the second spring 24 compressed.

If the first pivot arm 4, for example, deflects to the left with respect to the view in FIG. 1, then the second spring 24 is stretched and the first spring 23 is compressed.

Thus, if the first pivot arm 4 is deflected, then spring return forces are formed, which return the first pivot arm 4 from deflected positions into a neutral position.

FIG. 2 shows a schematic side view illustration of the first embodiment of a power supply device in accordance with the invention, this also being illustrated in FIG. 1. The side view is an illustration rotated by 90° with respect to the front view shown in FIG. 1. Hence, in FIG. 2 some of the same reference characters are used as in FIG. 1.

A first base rod 2 and a second base rod 3 are connected to a roof of a vehicle 1. The second base rod 3 is arranged in parallel to the first base rod 2. The first base rod 2 is connected to the vehicle 1 so as to be rotatable about a first axis 12 appearing projected in FIG. 2, and the second base rod 3 is coupled to the vehicle 1 so as to be rotatable in parallel to the first axis 12.

A first pivot arm 4 is in a deflected state. This deflected state is achieved, initiated and guided by a first rotary drive 8, via a first rotary movement of the first pivot arm 4 about the first axis 12. As shown in FIG. 1, the first pivot arm 4 can also be rotated about a second axis 13 via its connection to the first base rod 2 via a pivot joint 15 and a second rotary drive 9. Corresponding second rotary movements of the first pivot arm 4 about the second axis 13, for example, result in a deflection, as can be seen in FIG. 1.

A first guide rod system 16 and a second guide rod system 17, visible in FIG. 1, of a guide device 6 is articulated to the second base rod 3.

The first guide rod system 16 has a first guide rod 18 and a second guide rod 19, which are articulated to one another. In the deflected state of the guide device 6 shown in FIG. 2, the first guide rod 18 and the second guide rod 19 are arranged at an angle to one another. In the aforementioned deflected state, the second guide rod system 17 is also oriented at an angle, the same as the first guide rod system 16.

The first pivot arm 4 and the guide device 6 are articulated to a contact head 10 to form a current collector of the vehicle 1, where in the state shown in FIG. 2, the contact head 10 mechanically and electrically contacts a docking station 11 of a stationary charging station. In order to disconnect the contact head 10 from the docking station 11, the first rotary drive 8 and the second rotary drive 9 are actuated, so that the contact head 10 is lowered and the first pivot arm 4 and the guide device 6 are positioned onto the roof of the vehicle 1.

To reverse the deflection about the second axis 13, it is also conceivable in accordance with the invention to decouple the second rotary drive 9, as a result of which a spring return force of a spring device 7, described in connection with FIG. 1, becomes effective and returns the first pivot arm 4 and the guide device 6 to a neutral position in respect of the second axis 13.

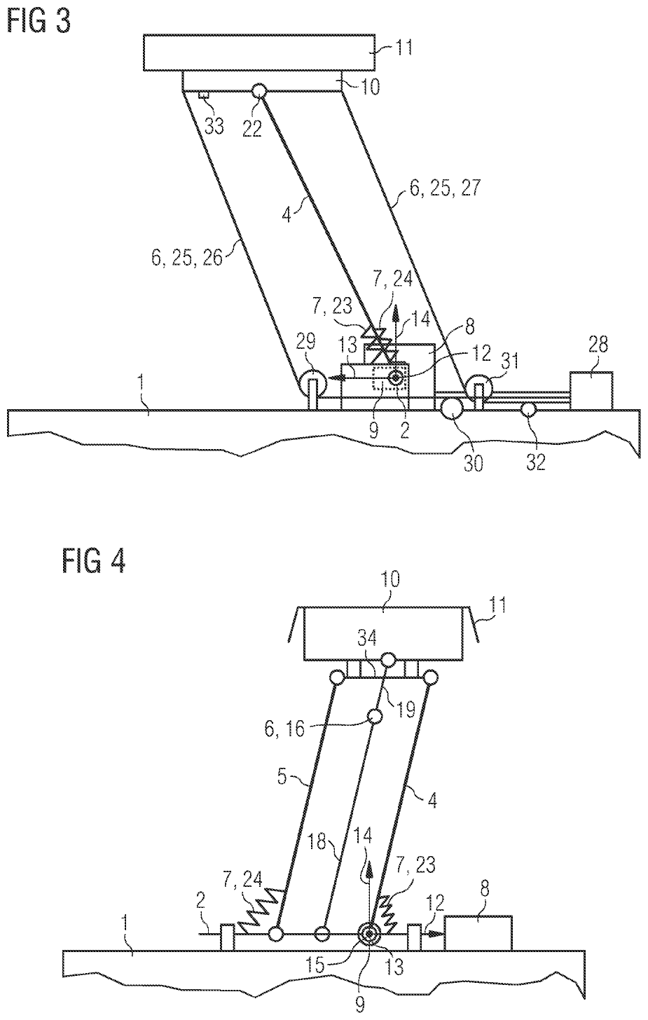

FIG. 3 discloses a schematic a front view illustration of an exemplary second embodiment of a power supply device in accordance with the invention arranged on a roof of an electric vehicle 1. This second embodiment resembles the first embodiment of a power supply device in accordance with the invention, as illustrated in FIG. 1.

Hence, in FIG. 3, some of the same reference characters are used as in FIG. 1.

In contrast to FIG. 1, a guide device 6 of the power supply device in accordance with the invention does not have a guide rod system, but rather a cable-pull arrangement 25. The cable-pull arrangement 25 comprises a first cable 26, a second cable 27 and two further cables, which are not visible in FIG. 3, because they are concealed by the first cable 26 and the second cable 27.

The first cable 26, the second cable 27 and the further cables are guided via guide rollers connected to the vehicle 1, where cable forces of the cables are governed by a control unit 28.

The first cable 26 is guided into the control unit 28 via a first guide roller 29 and a second guide roller 30, the second cable 27 via a third guide roller 31 and a fourth guide roller 32, and the further cables via further guide rollers.

The first cable 26, the second cable 27 and the further cables are connected to corners of a rectangular base area of a contact head 10, which is designed for the mechanical and electrical contacting of a docking station 11. The contact head 10 is connected to the vehicle 1 via a first pivot arm 4 as described in connection with FIG. 1. The first pivot arm 4 is coupled to the contact head 10 via a center of a base area of the contact head 10.

Depending on the tilt of the contact head 10, the cable forces of the cable-pull arrangement 25 are adjusted or varied in order to avoid any undesired tilting of the contact head 10. For example, if the corner of the base area of the contact head 10 at which the first cable 26 is connected to the contact head 10 moves downward in respect of the view illustrated in FIG. 3, then the second cable 27 is pulled in the direction of the control unit 28 (i.e., to the right with respect to the view in FIG. 3), so that the aforementioned corner of the base area of the contact head 10 is raised again. The contact head 10 is thus balanced on the first pivot arm 4.

A tilt angle sensor 33 is connected to the contact head 10, and sends corresponding tilt angle signals of the contact head 10 to a first rotary drive 8 via a signal line guided in the first pivot arm 4 and a first base rod 2. The first rotary drive 8 is in turn connected to the control unit 28 in a signal-conducting manner, as a result of which the tilt angle signals are evaluated in the control unit 28 and are used to adjust the cable-pull arrangement 25.

The control unit 28 is supplied with current via an accumulator (not shown) of the vehicle 1. In accordance with disclosed embodiments of the invention, it is also conceivable for the first cable 26, the second cable 27 and the further cables to be sheathed by protective tubes, for example.

FIG. 4 shows a schematic front view illustration of an exemplary third embodiment of a power supply device in accordance with the invention arranged on a roof of a vehicle 1.

This third embodiment resembles the first embodiment of a power supply device in accordance with the invention, as is illustrated in FIG. 1.

Hence in FIG. 4, some of the same reference characters are used as in FIG. 1.

In contrast to the first embodiment in FIG. 1, the power supply device in accordance with the invention in accordance with FIG. 4 has a first pivot arm 4 and a second pivot arm 5, where a guide device 6 merely comprises a first guide rod system 16.

A first base rod 2 is connected to the vehicle 1 so as to be rotatable about a first axis 12. A second base rod, not visible in FIG. 4, which is formed or arranged like the second base rod 3 visible in FIG. 2 and which is oriented in parallel to the first base rod 2, is connected to the vehicle 1 so as to be rotatable in parallel to the first axis 12.

The second base rod is arranged so as to be misaligned relative to the first base rod 2.

The first pivot arm 4 and the second pivot arm 5 are articulated to the first base rod 2 in relation to a second axis 13, which appears projected in FIG. 4. The first pivot arm 4 is hence mounted on the vehicle 1 so as to be rotatable about the first axis 12 and the second axis 13. The second pivot arm 5 is mounted on the vehicle 1 so as to be rotatable in parallel to the first axis 12 and in parallel to the second axis 13.

The first axis 12 and the second axis 13 are oriented at right angles to one another as axes of a Cartesian coordinate system.

Deflections of the first pivot arm 4 and of the second pivot arm 5 take place together, because the first pivot arm 4 and the second pivot arm 5 are articulated to one another via a connection rod 34. If the first pivot arm 4 and the second pivot arm 5 are deflected, then the first pivot arm 4 and the second pivot arm 5 are still oriented in parallel to one another.

FIG. 4 shows a deflection of the first pivot arm 4 and of the second pivot arm 5 about the first axis 12 into the image plane of FIG. 4 and to the right about the second axis 13. The deflection is initiated and guided via an electric first rotary drive 8 and an electric second rotary drive 9, which are supplied with current via an accumulator, not visible in FIG. 4, of the vehicle 1. The first rotary drive 8 is arranged on the roof of the vehicle 1 and is coupled to the first base rod 2. The second rotary drive 9 is coupled to a pivot joint 15, via which the first pivot arm 4 is connected to the first base rod 2.

First rotary movements of the first pivot arm 4 about the first axis 12 are initiated and guided via the first rotary drive 8, and second rotary movements of the first pivot arm 4 about the second axis 13 are initiated and guided via the second rotary drive 9.

A contact head 10, which in the deflection state in FIG. 4, is mechanically and electrically coupled to a stationary docking station 11 of a vehicle infrastructure formed as a charging station is articulated to the connection rod 34 and one end of the first guide rod system 16.

Comparably to parallelogram guidance, the contact head 10 performs translatory movements in parallel to the first axis 12 due to its connection to the connection rod 34 during pivoting movements of the first pivot arm 4 and the second pivot arm 5.

The first guide rod system 16 is structurally configured the same as described in connection with FIG. 1. It is articulated to the second base rod. The first guide rod system 16 moves along with the first pivot arm 4 and the second pivot arm 5 and supports the contact head 10 during deflections of the first pivot arm 4, so that unintended rotations of the contact head 10 in parallel to the first axis 12 are avoided.

Due to its connection to the connection rod 34, the contact head 10 is safeguarded against rotations in parallel to the second axis 13.

A first spring 23 of a spring device 7 is connected to the first pivot arm 4 and the first base rod 2, and a second spring 24 of the spring device 7 is connected to the second pivot arm 5 and the first base rod 2.

Viewed from the first pivot arm 4 and in the view in FIG. 4, the first spring 23 points to the bottom right, and the second spring 24, viewed from the second pivot arm 5, points to the bottom left. If the first pivot arm 4 and the second pivot arm 5, for example, with respect to the view in FIG. 4 and as illustrated in FIG. 4, deflect to the right, then the first spring 23 is compressed and the second spring 24 is stretched.

If the first pivot arm 4 and the second pivot arm 5, for example, deflect to the left with respect to the view in FIG. 4, then the second spring 24 is compressed and the first spring 23 is stretched.

Thus, if the first pivot arm 4 and the second pivot arm 5 are deflected, spring return forces are formed, which return the first pivot arm 4 and the second pivot arm 5 from deflected positions to a neutral position.

The spring device 7 is arranged outside a region bounded by the first pivot arm 4 and the second pivot arm 5. However, in accordance with disclosed embodiments of the invention, it is also conceivable for the spring device 7 to be arranged inside this region.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A power supply device for a vehicle, comprising:
at least one contact head which is contactable with a docking station to establish an electrical connection; and
at least one first pivot arm which is connected to the at least one contact head;
wherein the at least first pivot arm is connectable to a vehicle so as to be rotatable about a first axis and a second axis which are arranged at an angle to one another, the first axis extending parallel to a transverse vehicle axis and the second axis extending parallel to a longitudinal vehicle axis.

15. The power supply device as claimed in claim 14, further comprising:
a guide device which is connected to the at least one contact head to safeguard the at least one contact head against distortions relative to the at least first pivot arm;
wherein the guide device is connectable to the vehicle.

16. The power supply device as claimed in claim 15, further comprising:
a spherical joint arranged between the at least first pivot arm and the at least one contact head.

17. The power supply device as claimed in claim 15, further comprising:
a second pivot arm connected to the at least one contact head;
wherein the second pivot arm is connectable to the vehicle so as to be rotatable in parallel to the first axis and in parallel to the second axis;
wherein the second pivot arm is guided in parallel to the first pivot arm such that in an event of pivoting movements of the first and second pivot arms the at least one contact head performs a translatory movement.

18. The power supply device as claimed in claim 15, wherein the guide device is rod-shaped and is articulated to the at least one contact head and articulatable to the vehicle.

19. The power supply device as claimed in claim 16, wherein the guide device is rod-shaped and is articulated to the at least one contact head and articulatable to the vehicle.

20. The power supply device as claimed in claim 17, wherein the guide device is rod-shaped and is articulated to the at least one contact head and articulatable to the vehicle.

21. The power supply device as claimed in claim 15, wherein the guide device is formed as a cable-pull arrangement which is connected to the at least one contact head and which is connectable to the vehicle; and
wherein the cable-pull arrangement is configured such that the at least one contact head is balanceable by adjusting cable forces on at least the first pivot arm.

22. The power supply device as claimed in claim 16, wherein the guide device is formed as a cable-pull arrangement which is connected to the at least one contact head and which is connectable to the vehicle; and
wherein the cable-pull arrangement is configured such that the at least one contact head is balanceable by adjusting cable forces on at least the first pivot arm.

23. The power supply device as claimed in claim 17, wherein the guide device is formed as a cable-pull arrangement which is connected to the at least one contact head and which is connectable to the vehicle; and
wherein the cable-pull arrangement is configured such that the at least one contact head is balanceable by adjusting cable forces on at least the first pivot arm.

24. The power supply device as claimed in claim 21, further comprising:
a protective tube which sheaths at least one first cable in the cable-pull arrangement.

25. The power supply device as claimed in claim 14, wherein a spring device is at least connected to the first pivot arm and is connectable to the vehicle; and wherein the spring device is adjusted such that in an event of the pivot arm deflecting from a neutral position a spring return force is formed on at least the first pivot arm.

26. The power supply device as claimed in claim 14, wherein the first axis and the second axis are formed as axes of a Cartesian coordinate system.

27. The power supply device as claimed in claim 14, wherein at least the first pivot arm is connected to the at least one contact head to form a current collector.

28. The power supply device as claimed in claim 14, wherein the docking station is arranged in a stationary manner.

29. The power supply device as claimed in claim 14, wherein the vehicle is a utility vehicle.

30. The power supply device as claimed in claim 29, wherein the utility vehicle is an electric bus or an electric truck.

31. A vehicle with the power supply device as claimed in claim 14.

32. A vehicle infrastructure with the power supply device as claimed in claim 14.
